(19) United States
(12) Patent Application Publication
(10) Pub. No.: US 2017/0103435 A1
(43) Pub. Date: Apr. 13, 2017

(54) NETWORKED REQUEST FULFILLMENT AND OFFER/ACCEPTANCE COMMUNICATIONS

(71) Applicant: ReplyBuy, Inc., Scottsdale, AZ (US)

(72) Inventors: Anthony Saia, Scottsdale, AZ (US); Joshua Manley, Scottsdale, AZ (US)

(21) Appl. No.: 15/288,159

(22) Filed: Oct. 7, 2016

Related U.S. Application Data
(60) Provisional application No. 62/238,383, filed on Oct. 7, 2015.

(51) Int. Cl. G06Q 30/06; G06Q 10/08

(52) U.S. Cl. CPC G06Q 30/0601; G06Q 10/087

(57) ABSTRACT

A system and method for fulfilling orders from users via networked computing systems are disclosed. In one implementation, the system and method allows a user to input their contact and payment information and a request to be contacted when and if item that they desire becomes available for sale. The system and method may ingest the requests from a plurality of users, create custom fulfillment requests for the individual users and generate an individualized custom communication for each user in order to alert the user to the availability of their specific request and make them a custom offer which may have to be communicated in a specific time period based on parameters ingested.

### PRIORITY CLAIM/RELATED APPLICATION

This application claims priority under 35 USC 120 and the benefit under 35 USC 119(e) to U.S. Provisional Patent Application Ser. No. 62/238,383 filed on Oct. 7, 2015 and entitled “Networked Request Fulfillment and Offer/Acceptance Communications”, the entirety of which is incorporated herein by reference.

### TECHNICAL FIELD

This application relates to the field of networked communications and fulfilling purchase requests remotely.

### BACKGROUND

In order for a user to purchase items, a repository of items was previously needed. If stock in the items became low or was unavailable, the user would not be able to complete the transaction.

### SUMMARY

Systems and methods here may be used to receive a request from a user, and fulfill that request when the inventory became available. Such request fulfillment could be accomplished remotely, using any of various communication methods such as offer and acceptance via text message to and from a smartphone.

### BRIEF DESCRIPTION OF THE DRAWINGS

FIG. 1 is an example of an implementation of an order fulfillment system.

FIG. 2 is a flow chart describing one example method which may be used to practice the embodiments disclosed herein.

FIG. 3 is an example flow chart showing an overview of a request fulfillment according to certain embodiments disclosed herein.

FIG. 4 is an example network diagram and GUI showing example selection and message conversations according to certain embodiments disclosed herein.

FIG. 5 is an example screenshot of a graphical user interface GUI of a message according to certain example embodiments disclosed herein.

FIG. 6 is an example screenshot of another graphical user interface GUI of a message according to certain example embodiments disclosed herein.

FIG. 7 is an example screenshot of another graphical user interface GUI of a message according to certain example embodiments disclosed herein.

FIG. 8 is an example network diagram showing payment example embodiments as disclosed herein.

FIG. 9 is a flow chart showing network features and GUI examples according to certain embodiments disclosed herein.

FIG. 10 is a flow chart showing network features and GUI examples according to certain embodiments disclosed herein.

FIG. 11 is a flow chart showing network features and GUI examples according to certain embodiments disclosed herein.

FIG. 12 is a flow chart showing network features and GUI examples according to certain embodiments disclosed herein.

FIG. 13 is a flow chart showing network features and GUI examples according to certain embodiments disclosed herein.

FIG. 14 is a flow chart showing example network features according to certain embodiments disclosed herein.

FIG. 15 is a flow chart showing example network features according to certain embodiments disclosed herein.

FIG. 16 is a diagram of example computer components used to practice certain embodiments disclosed herein.

### DETAILED DESCRIPTION

Reference will now be made in detail to embodiments, examples of which are illustrated in the accompanying drawings. In the following detailed description, numerous specific details are set forth in order to provide a sufficient understanding of the subject matter presented herein. But it will be apparent to one of ordinary skill in the art that the subject matter may be practiced without these specific details. Moreover, the particular embodiments described herein are provided by way of example and should not be used to limit the scope of the invention to these particular embodiments. In other instances, well-known data structures, timing protocols, software operations, procedures, and components have not been described in detail so as not to unnecessarily obscure aspects of the embodiments of the invention.

Overview

Customers using networked shopping infrastructure sometimes make requests that go unfulfilled or make a request to be reminded at a later time. This could be because inventory is unavailable for some reason or the customer is not currently interested in buying but might be at a later time. Connecting users who are willing to make a purchase with their requested order is beneficial for all parties involved. The vendor sells more product/service, and the user receives the desired request.

Certain embodiments here include systems and methods to fulfill orders from users via networked computing systems. For example, a user may shop for an item event on a vendor website. They may input parameters for their desired purchase. But for one reason or another, due to inventory unavailability at the time the particular user attempts to buy the product, their desired choice is not available or is not available for their desired price range. In such an example, the systems here may allow the user to input their contact and payment information and a request to be contacted when and if item that they desire, later do become available for sale. Then, the system may ingest all of the many request, create custom fulfillment requests for the individual users, generate an individualized custom communication for each user in order to alert the user to the availability of their specific request and make them a custom offer which may have to be communicated in a specific time period based on parameters ingested. The system may then receive an acceptance of the customized offer via a wireless communication and complete the transaction using the previously input user information. In such a way, the user receives what they originally requested, and the vendor completes a sale they would have otherwise lost.

It should be noted that the example of a user purchasing a ticket for a live event is sometimes used in this application. This example is not intended to be limiting. Rather, the systems could be used for allowing users to fulfill transactions for any kind item wherein the item may be one of a product and/or a service. Examples include but are not limited to tickets to live events, tickets to movies, tickets for transportation such as airlines, bus, cruise, or other transportation, products such as consumer goods, real estate, services such as electricians, plumbers, dentists, doctors, painters, contractors, construction, lawn care, cleaners, or any other service.

Network Examples

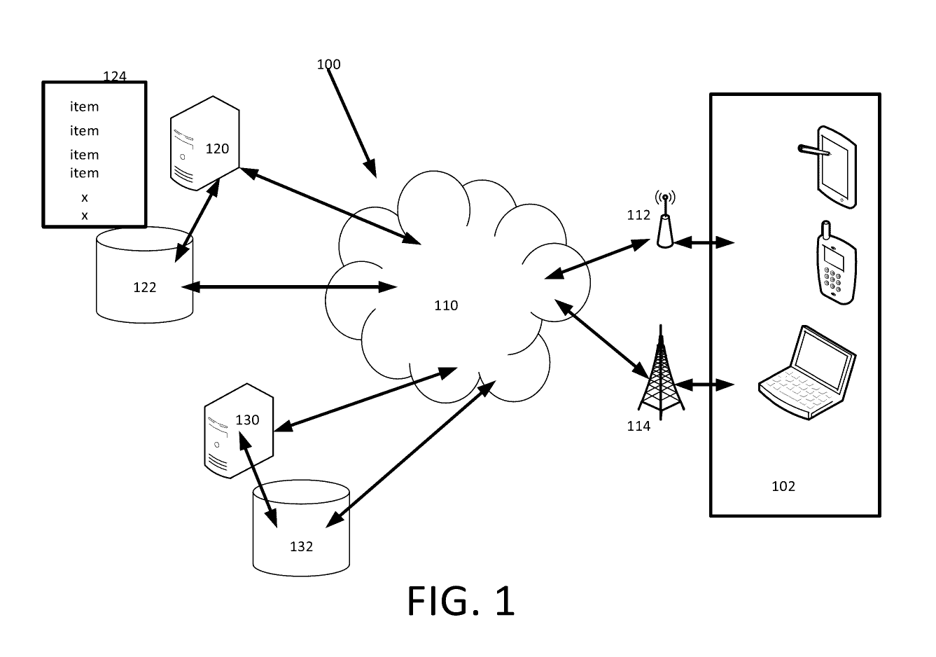

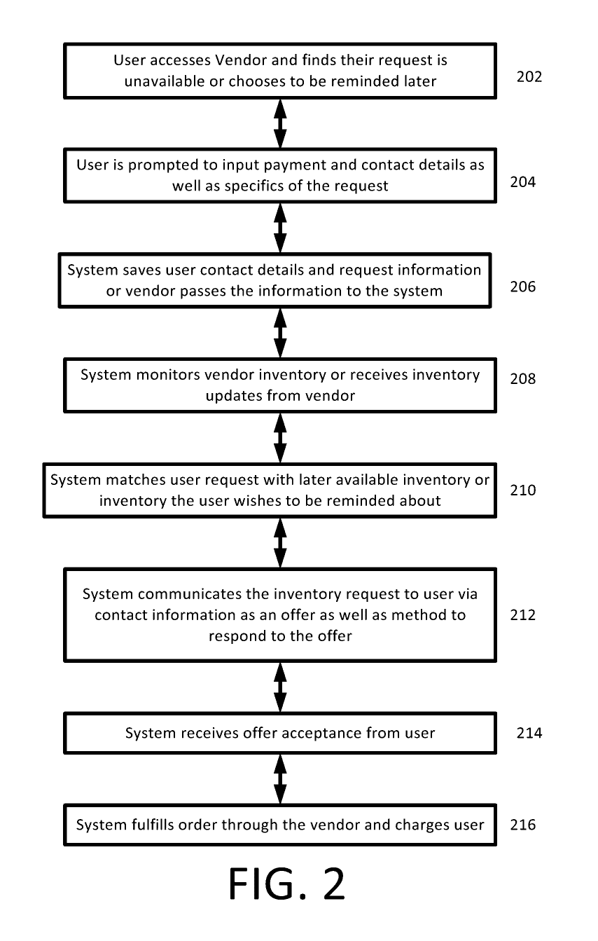

FIG. 1 illustrates an example of an implementation of a request fulfillment system 100 that may be used to perform, for example, to perform the method shown in FIG. 2. The system may be a network in which users, using any of one or more computing devices 102, such as smartphones, laptops, personal computers, tablet computers, wearable computers such as glasses and watches, or other computing devices, connect to a vendor server 120 via a network 110 such as the internet. The connection can be through any of various wired or wireless communications such as cellular 114 or WiFi 112 or any other connection such as Bluetooth Low Energy, Near Field Communications, or other way. The vendor server 120 in this example is a networked vendor of some type of product or service with accessible data storage 122.

Additionally, FIG. 1 includes a back end system 130 which receives information, processes information, makes determinations and stores data in a data storage 132. The back end systems may be either available to the user 102 through the vendor 120 system, or available to the vendor itself 120, through the network 110. The back end system 130 may have an interface or API that is able to communicate with each vendor system 120 and receive availability data for an item to be purchased. Such back end systems 130 are able to receive information about a particular user through their computing devices using an interface/graphical user interface or API such as using their smartphones 102, wherein the data may include contact information and payment information. The back end systems 130 are able to store such information in a data storage 132, and also store details of the user's request. By accessing the vendor 120 on a periodic or constant basis, and/or by receiving updates from the vendor 120, the back end systems 130 here may learn of changes or developments in the availability of services or products 124 for sale by the vendor. The back end systems 130 can then match the stored request with the newly available product or service 124 (such as by using an matching engine or system that is part of the back end system), and alert the user through their smartphone 102 who made that specific request (such as by using an alerting engine or system that is part of the back end system), using the contact information the user previously entered into the system. In certain examples, the system may then send a communication to the user's smartphone 102 and receive an acknowledgement of purchase from the user. Such a communication may be via short message service SMS text message, over the top (OTT) messaging platforms like Facebook Messenger, WhatsApp and the like, multimedia messaging service MMS, or through a cellular network connection 114. By replying with an affirmative response, the user can place the order for the required product or service, and the back end systems 130 can then fulfill the request through the vendor systems 120.

It should be noted that the wireless communications could be through any of various forms including but not limited to cellular, 3G, 4G LTE, 5G, etc., WiFi, Bluetooth Low Energy, Near Field Communication, pico cell, nano cell, or any other kind of communication. The wireless computing device utilized by any of various users could be any kind of wireless computing device including but not limited to a smartphone, a laptop, a wearable computer such as glasses or a watch, an automobile, an appliance, or any other kind of computing device capable of communicating remotely. The term smartphone, as used herein is not intended to be limiting. The description here uses many use examples which are not intended to be limiting. Many examples discuss purchasing tickets to a live event but this example could be any example of a product and/or service for sale. Thus, the ticket examples are not intended to be limiting.

Request Fulfillment Examples

In certain example embodiments, the systems here may communicate with users who have indicated their desire for a product or service. Such a communication may have not only the information about the offer, but an explanation of the offer, and a way for the user to respond and purchase the offered products or service.

For example, for a ticket purchase, the system may send the following message with the details and a method for complete the purchase (reply with: BUY NOW):
Great news Tim! We just found the 4 Floor Seats you requested for Cleveland Cavaliers vs Golden State Warriors, Thursday 11/6 at 7 PM at Oracle Arena. You'll be seated in Sec F2, Row 1 for $250/ea. To compete this purchase, reply with: BUY NOW

As another example, for a previously unavailable concert ticket, the system may send the following message with the details and a method for complete the purchase (reply with: BUY):
Hi Josh! The tickets you requested for Bon Jovi just became avaliable. Jones Beach Arena, Saturday 7/6 at 6 PM. You will be located in Section GA for $79/ea. Reply “BUY” to complete your purchase now.

As yet another example, for a product like a pair of previously requested shoes, the system may generate the following message with the details and a method for complete the purchase (reply with: BUY JORDANS):
Tony the sneakers you requested are in! Air Jordan 5 Retro Obsidian/Metallic, size 10. These are $180, which is includes shipping to your location in Tempe Ariz. Reply “BUY JORDANS” to complete your purchase now.

FIG. 2 is an example of methods steps that may occur in order for the systems to receive and fulfill a user request. The example steps as shown in FIG. 2 pick up after a user has already established an account with the system and/or the vendor has accepted and passed on account information to the system.

In certain example embodiments, a widget or other hosted item could be used by the systems here to collect user information within or through the vendor website. In certain example embodiments, the vendor website may collect user information and pass it along to the systems here. In either way, the systems may gather the requisite user information in order to bill, contact, identify, email, ship, or otherwise locate the specific users.

In certain example embodiments, once an account has been established, the system may use cookies or other internet browser software scripts in order to provide the services as described herein through online vendors that may be different than the vendor the user first visited. In certain example embodiments, the cookies may be used for the same vendor, on another visit by the same user. In such a way, the abilities that the service provides to users as described herein may be readily available to the users, without having to sign in each time, or sign in multiple times. Instead, the abilities are presented to a user each time.

In the example, after account establishment, a user first logs into a vendor system to shop and finds that their request is unavailable or chooses to be reminded later about their desired product or service 202. This could be a user trying to buy tickets to a live event through a ticket broker, it could be a user trying to buy a product from a product sales website, or any of other various vendors. Next, the user, if she has not already done so, finding that their desired purchase is unavailable for whatever reason, is prompted to input information so that they may be later contacted for a follow up 204. Once the user has established this information with the system each subsequent visit to this and/or other vendors may allow the system to recall the information so it does not have to be input multiple times as later described herein. Such a prompt may ask for payment details such as a credit card number or checking account number, so if the user later accepts the offer, they may be billed. In certain embodiments the system may tokenize the payment information and/or otherwise encrypt or secure in a PCI compliant method. Such a prompt may include asking for user contact details such as a phone number, email address, post office address, instant message handle, or any other contact information. The prompt may also include specifics of the request that the user desires. For example, price ranges they are willing to pay, the seats they desire, the quantity of products they desire, the area of service they desire, etc.

In certain examples, data submitted by the user may include one or more of the following as part of the request: mobile phone number, email address, first and last name, preferred event, such as the event name or event identifier, preferred event date and/or time, preferred ticket price range such as a minimum price and/or maximum price, or both, preferred ticket seat location such as one or more of Section, Row, Seat, and/or preferred ticket quantity.

Next, the system saves the input information from the user or the vendor passes this information to the system 206. Next, the system monitors the inventory from the vendor, or is sent inventory updates from the vendor 208. In this way, the system is able to keep track of what inventory becomes available at different times. Next, the system attempts to match up the stored user requests with the later available inventory or inventory the user wishes to be reminded about 210. If a match is made by the system, the system them communicates the inventory request to the user via the contact information that the user previously input, the communication coming in the form of an offer for the desired product or service 214. This communication may also include instructions of how to properly make the acceptance to the offer. In certain examples, this is an SMS text message to the user's smartphone indicating that the desired tickets are available and if the user wants them they must reply with a code word and quantity of requested tickets. If the user does respond positively to the offer, and accepts the offer, their response is sent to the system which receives the acceptance 214. Finally, the system fulfills the order through the vendor and charges the user using the previously input payment information 216.

In certain example embodiments, such a communication could be any of an SMS text message, an email, an instant message, a message through a software application, a phone call, or any of other examples. Many examples in this description indicate use of an SMS text message but this example is not intended to be limiting.

Overview Flowchart Example

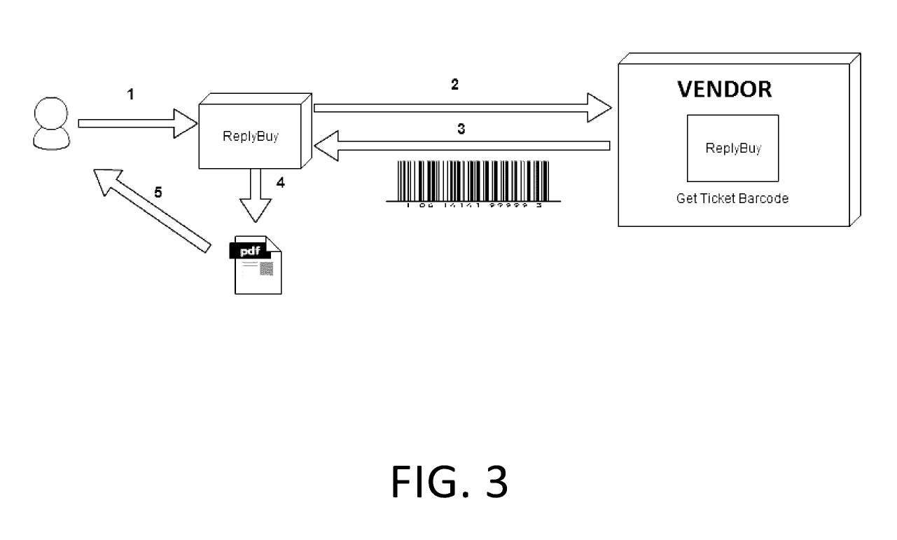

In FIG. 3, a flow chart shows an example exchange between a user, the system and a ticket sale vendor. In step 1, the user logs into the system online and sets up an account. The information that the system may procure from the user in the account setup may be the payment information, contact information, etc. Next, in step 2, the user makes a selection of a ticket, through the system page with the vendor. As described herein, this step may include approval for the system to contact them in the event that their original request is not available. In step 3, the ticket vendor fulfills the request and sends the barcode for the selected service to the system. In certain examples, the order fulfillment of step 3 does not take place at the time the user makes the original request, such as in cases where the original request is not available. In such examples when the user makes her original request for a ticket and that selection is not available, then the system will store the desired request. Through either monitoring or receiving updates of inventory, the system may receive the order fulfillment, in this case a ticket barcode, when it becomes available. In either case, in step 4, when the system receives the barcode, it may be attached to another file, such as a PDF file or the barcode may be presented within an application such as a mobile application or via a mobile enabled website. In step 5, the system transmits the file with the ticket barcode on it to the user's computing device, such as in a text message to a user's smartphone. In such a way, the user can then store the file with the barcode or access the barcode when the ticket is used.

Monitor Setup Examples

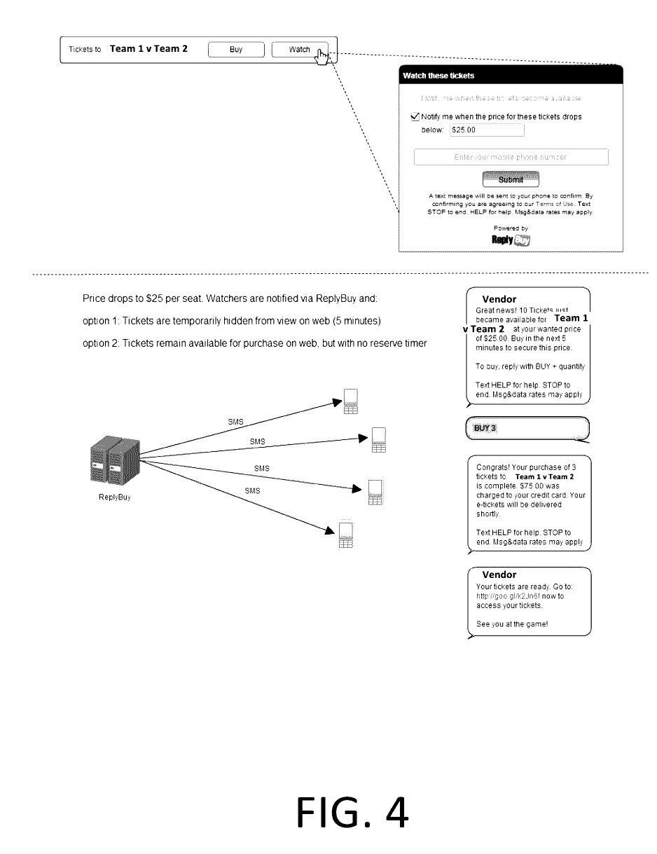

In FIG. 4, a graphical user interface GUI is shown which may be presented to a user who is not able to purchase what they desire at the time they first access the vendor. In such an example, the user may click on a button shown here as a button labeled “Watch” for example, instead of Buy, to enable a monitoring function for the requested product or service. Such a monitoring function may give access to a screen that allows more details to be included by the user. The user may select to receive a notification if the intended purchase becomes available. Certain embodiments allow for a price limit or range to be entered as well. Another entry may allow for a mobile phone number to be entered so that the system may contact the user in case the desired tickets become available later.

FIG. 4 also shows an example back end system contacting one or multiple users via an SMS text message when the price falls within the requesting user's price range and/or the requested tickets otherwise become available.

In certain embodiments, the tickets are temporarily hidden from view on the web for a given time period while the requesting users are contacted.

In certain embodiments, the tickets remain available for purchase on the web but with no reserve timer.

FIG. 4 also shows an example back- and-forth text message conversation between the system and a user. First, the system sends a text message to a user with information about the tickets that they had been searching for. The message not only informs the user that the tickets are available but how to complete the purchase, with instructions on a reply message. Such an arrangement can cut down on erroneous reply messages which are misinterpreted as acceptances of an offer. In this example, the instruction is to reply to the offer with a text message including the word “Buy” and the number of tickets requested.

Next, the system sends a confirmation text message for the purchase. And finally, a message is sent that includes a hyperlink or other mechanism to allow the user to access the tickets. In this example, the ticket has a unique barcode as an example.

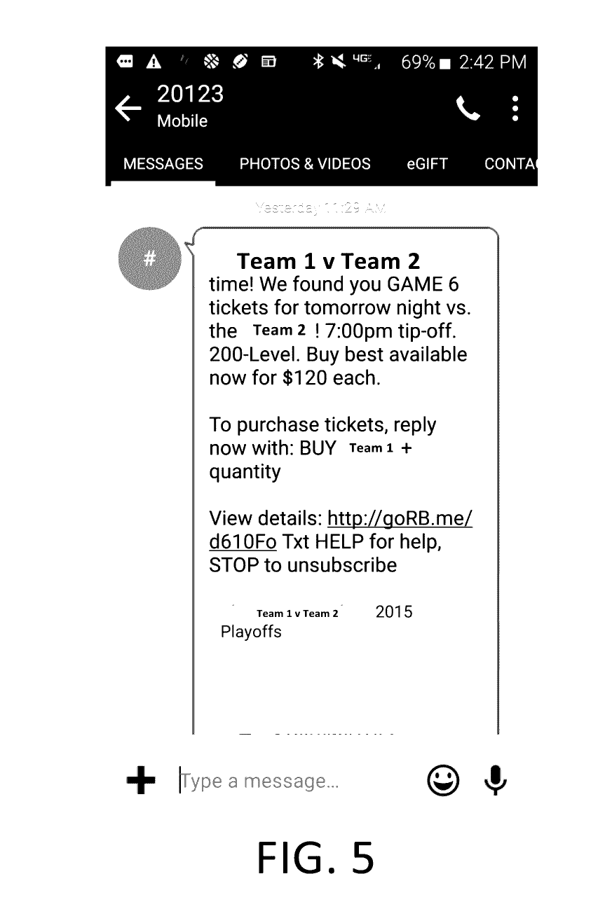

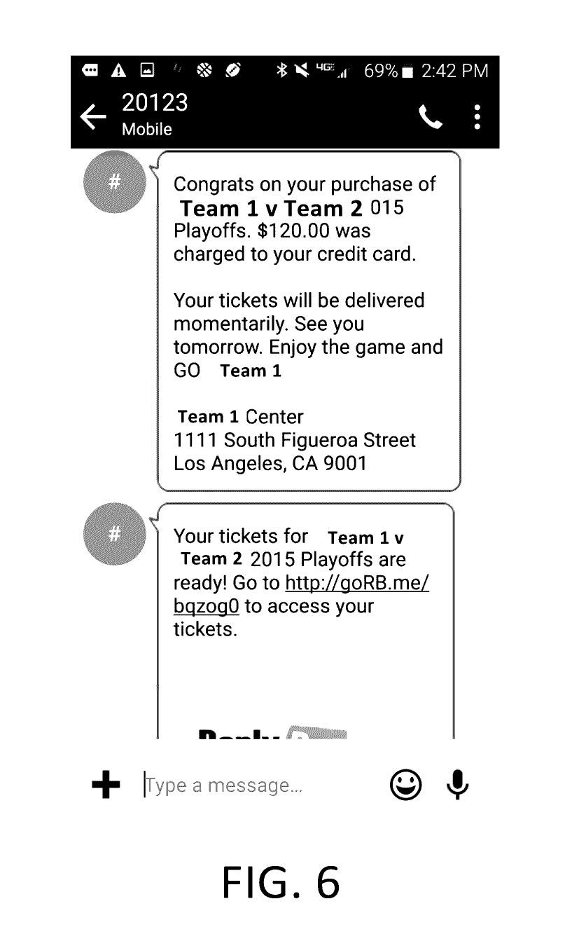

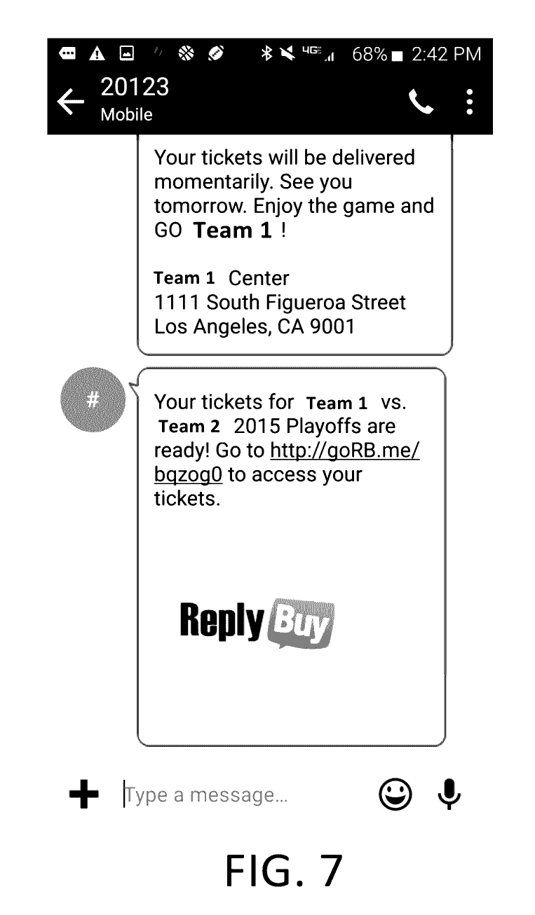

FIGS. 5, 6 and 7 show more example of text message conversations similar to those described above.

Payment Example

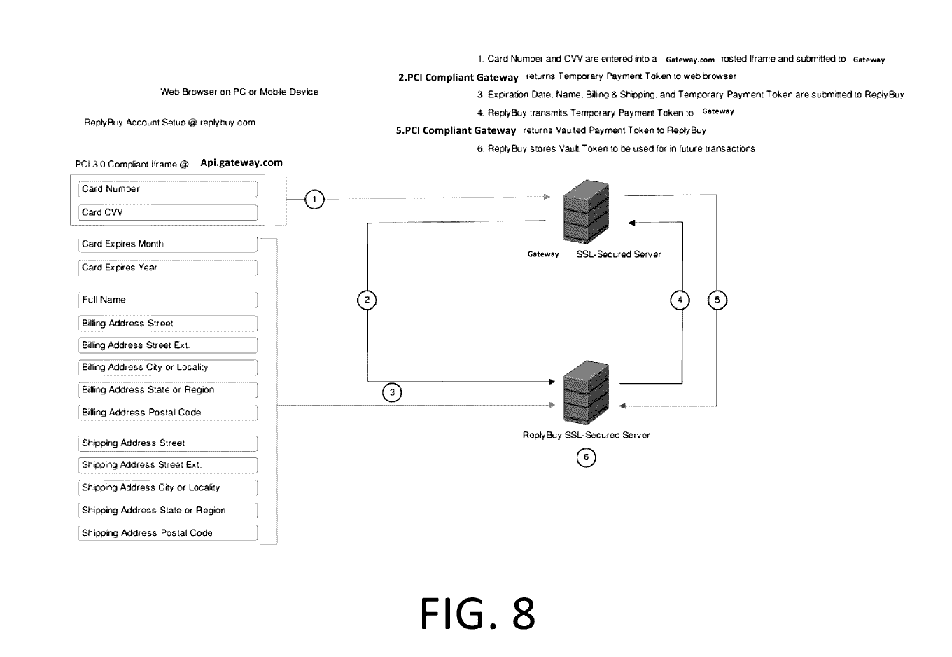

FIG. 8 shows example network steps the back end systems may take in payment example embodiments. A user may set up an account via a web browser on a mobile or non-mobile computing device. Back end systems include Payment Card Industry PCI compliant gateway SSL secured server and a system SSL secured server.

In the example, in step 1 the card number and CVV or other identifying number are entered into a hosted iframe and submitted to PCI compliant gateway.

Next, in step 2, PCI compliant gateway returns a payment token to web browser. Next, in step 3, the expiration date, Name, billing and shipping addresses and temporary payment token are submitted. Next, in step 4, the system transmits temporary payment token to PCI compliant gateway. In step 5, PCI compliant gateway returns vaulted payment token to the system. In step 6, the system stores the vault token to be used in future transactions.

More Network Flow Chart Examples

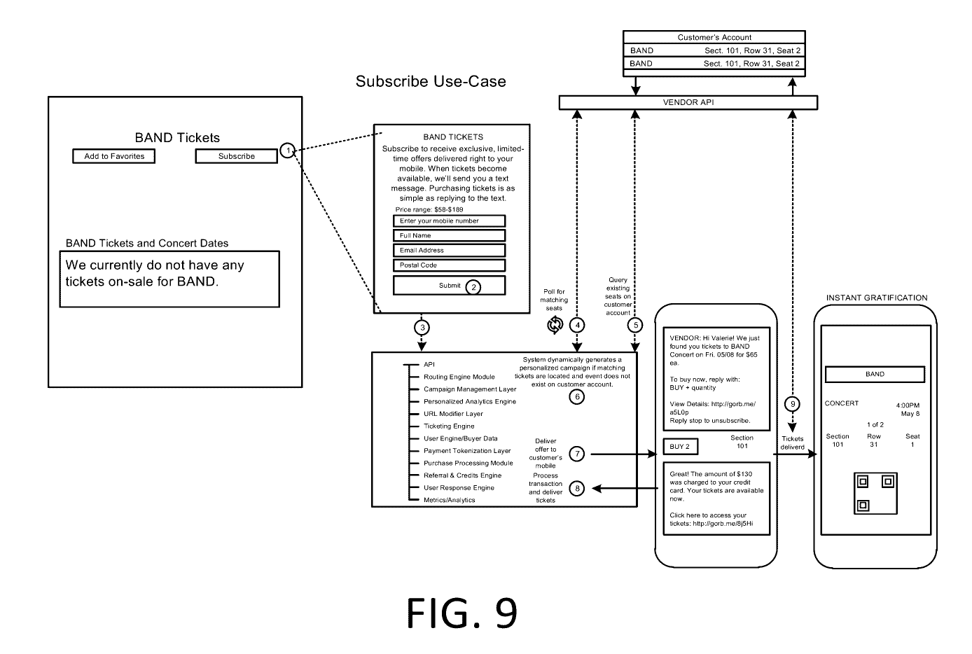

FIG. 9 is a flow chart showing example steps that may be taken by the back end in certain embodiments where a user searches for a ticket that is not available when they search because of the requested time, date, venue, price, etc., but allows the user to be notified about later inventory availability along with GUI examples of what the user may see on her smartphone during the process.

In step 1, the user is searching on a website from either a mobile or no mobile device for a concert ticket. It should be noted that in this example, it is assumed that the user has already created a login or otherwise submitted payment instructions to the system. This allows the system to charge the appropriate account should an offer be accepted. In certain embodiments, this payment information may be collected during step 2 or another step along the request process.

The example concert that the user in FIG. 9 is searching is sold out or unavailable for some reason. Although the user is not able to purchase the ticket they are requesting immediately, they are able to “subscribe” to this concert. In such a way, the user may to continue to pursue the tickets, despite being told that they are sold out, for the moment—and the user may give the system the required information for the system to later reach out and offer tickets should they become available.

In step 2, the user is prompted to input more information about the request—price range, mobile phone number and/or other contact information, name, email, home address, etc. This information may allow the system to contact the user at a later time. Next, in step 3, the user submits the request to stay abreast of the concert information. In this step, the system is able to, through various back end systems including the API, routing engine module, campaign management layer, personalized analytics engine, URL modifier layer, Transfer Engine, User login/buyer data, payment transactions layer, purchase processing module, referral and credits engine, user response engine, and/or metrics/analytics conduct the matching, contact and fulfillment processes. Each of the backend systems described herein may be implemented in software (a plurality of lines of instructions/computer code) that may be executed by a processor of a computing resource of the backend system or may be implemented in a hardware device.

The application program interface (API) will allow widgets and vendor applications to communicate with the system programmatically via widely used internet based commutation protocols, including but not limited to hypertext transfer protocol (HTTP) and HTTP Secure (HTTPS), Sockets, Simple Object Access Protocol (SOAP) and Short Message Peer-to-Peer (SMPP). In this manner, the widgets can submit Requests to the system, which will in turn be queued by the Request Queue for processing. In addition, vendors may proactively submit Inventory Updates to the system, which will in turn be digested by the Inventory Management Engine (IME) and used to update the Inventory Cache.

The campaign management layer may Offer details including but not limited to price, date/time, venue location, seating location, item details, images, and terms and conditions are generated and packaged together as a Campaign. This allows us to retain information about commonly requested events, items etc. It also allows us to hyperlink these details, to allow viewing via a Mobile App or web browser. In this way, additional offer information can be easily presented to the user in a way that may not be possible with a text message alone.

The URL modifier layer is used so that campaigns can be hyperlinked and embedded into a Mobile App, Mobile and Desktop enabled website. The URL used to access the Campaign may be modified in a number of ways to include user identifying parameters and/or reference tokens to create custom experience when the Campaign is viewed by a user. The URL can also be shortened and/or disguised for convenience and to restrict length for the purpose of injecting into text messages. These functions may be performed by the URL modifier layer.

The ticketing engine may perform operations for those requests related to event, travel and other ticketing related vendors. In particular, 3rd party API integrations are in place to enable near real-time access to vendor specific ticketing data, including but not limited to event details, seating information, seat barcodes and/or access management credentials, serial numbers and customer account information. In this way, the system can provide for rapid order fulfillment and instant user gratification.

The user engine/buyer data may, once a new request is received and begins processing, check if a Mobile Profile already exists for the request user. If one does not already exist, one will be created. Once a Mobile Profile has been created for a user, the user gains access to log in to an account portal. There the user can update personal information, preferences and interests, location, payment information, billing and shipping address, authorizations and passwords. The user can also access purchase history. invoices, and in the case of ticketing, access PDF and mobile tickets.

The payment tokenization layer may perform the process for configuring the payment and generating the payment token. Specifically, when a user is presented with the opportunity to select a payment method, the user will be asked to setup a billing agreement. The user may enter the appropriate payment account information, including but not limited to credit card details, 3rd party payment system credentials such as PayPal, Amazon Pay, Apple Pay, Google Pay, Samsung Pay etc, and billing and shipping address. This information is transmitted and processed in accordance with PCI compliant regulatory requirements. The result is a persistent payment token, specific to this system and to this user's Mobile Profile, that may store securely and applied to future purchase transactions.

The purchase processing module may perform various payment processing. For example, whenever the system determines that a purchase request has been sent by a user, the payment token linked to the user's Mobile Profile is accessed and transmitted to a payment facilitation system, credit payment gateway or 3rd payment processing system API, including such parameters as order number, unit price, quantity, total price, discount, and tax or VAT. A successful or failed payment response is returned to the system and notification is generated to be transmitted back to the user.

The referral and credits engine may perform incentivizing operations. For example, users may be incentivized by the vendor and/or system operator to perform specific tasks or accomplish certain goals, such as setting up payment method, completing one or more purchases, or referring one more friends to do the same. The user may be awarded some amount of credit for each action they perform, which may be applied to their Mobile Profile and/or to future purchase.

The user response engine handles user responses. For example, once a user submits a request or replies to a message from the system, the system goes through a process of identifying the user's Mobile Profile and determining the user's intent. In any case, the system will also be able to determine the appropriate message response to routed and delivered back to the user's mobile phone or mobile device. For every interaction with the system, the user should expect to receive a response back from the system, in the form of a mobile message, app notification or web page load.

The metrics and analytics unit, for activities applied to and occurring within the system, the system will be capable of parallel tracking all user and system events for the purpose of real-time/offline analysis. This will allow system operators to measure performance, engagement, and conversion rates. This data can also be delivered back to the vendor through API and/or HTTP, HTTPS, file transfer protocol (FTP), secure FTP (SFTP), or any number of other data transfer protocols.

In step 4, the system communicates with the vendor and attempts to match the request with the available inventory. In step 5, the customer account information is also communicated from the vendor. In step 6, the customer account is updated. In step 7, the message is sent to the user's mobile phone, indicating that the request has been matched and that there is available inventory to be had. In step 8, the user sends a purchase acceptance with the mobile smartphone. After the back end system accepts the payment from the user, the bar code information is sent from the vendor to the user's mobile smartphone device. This is the information the user will utilize as the ticket, in this example.

Presale or Request before Public Release Examples

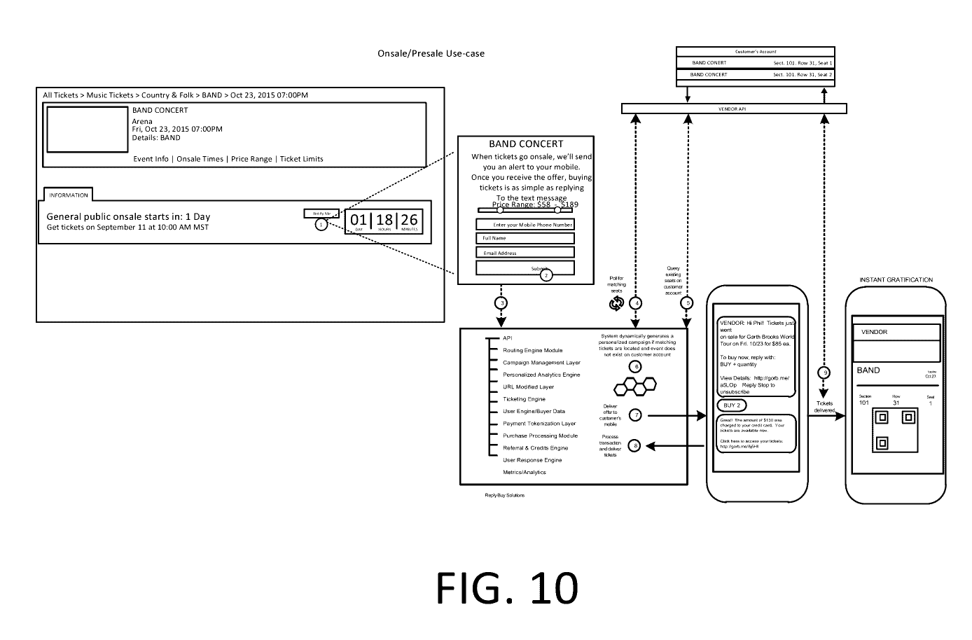

FIG. 10 is another flow chart showing example steps that may be taken in certain embodiments herein to match a request with inventory and approve the transaction via text message.

In FIG. 10, an example GUI is shown in which a user requests to subscribe to a concert information service, before the tickets are available for release to the public. The user is hoping to be able to purchase tickets before they sell out, and wants to increase her chances by getting in line before the public release date.

In step 1 the user clicks a button on the GUI which tells the system that she wishes to be notified of ticket availability. In step 2, the user is prompted to input more information about the request—price range, mobile phone number and/or other contact information, name, email, home address, etc.

Next, in step 3, the user submits the request to stay abreast of the concert information. In this step, the system is able to, through various back end systems including the API, routing engine module, campaign management layer, personalized analytics engine, URL modifier layer, Transfer Engine, User login/buyer data, payment transactions layer, purchase processing module, referral and credits engine, user response engine, and/or metrics/analytics conduct the matching, contact and fulfillment processes.

In step 4, the system communicates with the vendor and attempts to match the request with the available inventory. In step 5, the customer account information is also communicated from the vendor. In step 6, the customer account is updated. In step 7, the message is sent to the user's mobile phone, indicating that the request has been matched and that there is available inventory to be had. In step 8, the user sends a purchase acceptance with the mobile smartphone. After the back end system accepts the payment from the user, the bar code information is sent from the vendor to the user's mobile smartphone device. This is the information the user will utilize as the ticket, in this example.

Examples of Future Match Arrangement Requests

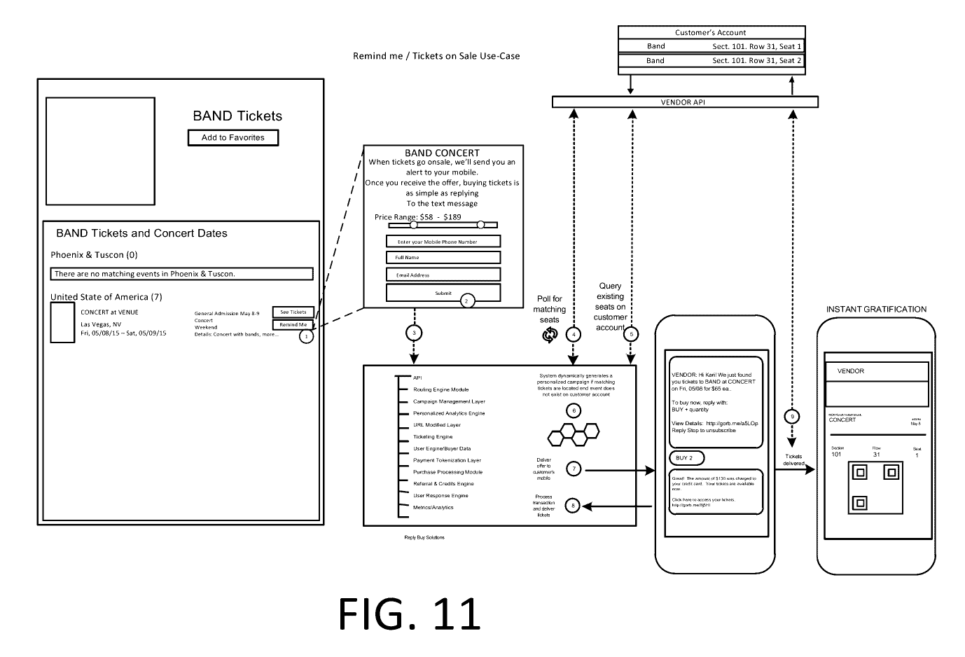

FIG. 11 is a flow chart showing steps to remind a user, and set up a future match. In step 1, the user is presented with a GUI which offers the ability to “See Tickets” and to “Remind Me.” The “Remind Me” button allows the user to set up a future arrangement where the system attempts to match their request with inventory, but at a future date. This may be even if there are certain tickets available at the time the user first accesses the web page, but wishes to wait until a later date to make a decision.

In step 2, the user is prompted to input more information about the request—price range, mobile phone number and/or other contact information, name, email, home address, etc.

Next, in step 3, the user submits the request to stay abreast of the concert information. In this step, the system is able to, through various back end systems including the API, routing engine module, campaign management layer, personalized analytics engine, URL modifier layer, Transfer Engine, User login/buyer data, payment transactions layer, purchase processing module, referral and credits engine, user response engine, and/or metrics/analytics conduct the matching, contact and fulfillment processes.

In step 4, the system communicates with the vendor and attempts to match the request with the available inventory. In step 5, the customer account information is also communicated from the vendor. In step 6, the customer account is updated. In step 7, the message is sent to the user's mobile phone, indicating that the request has been matched and that there is available inventory to be had. In step 8, the user sends a purchase acceptance with the mobile smartphone. After the back end system accepts the payment from the user, the bar code information is sent from the vendor to the user's mobile smartphone device. This is the information the user will utilize as the ticket, in this example.

Map Examples

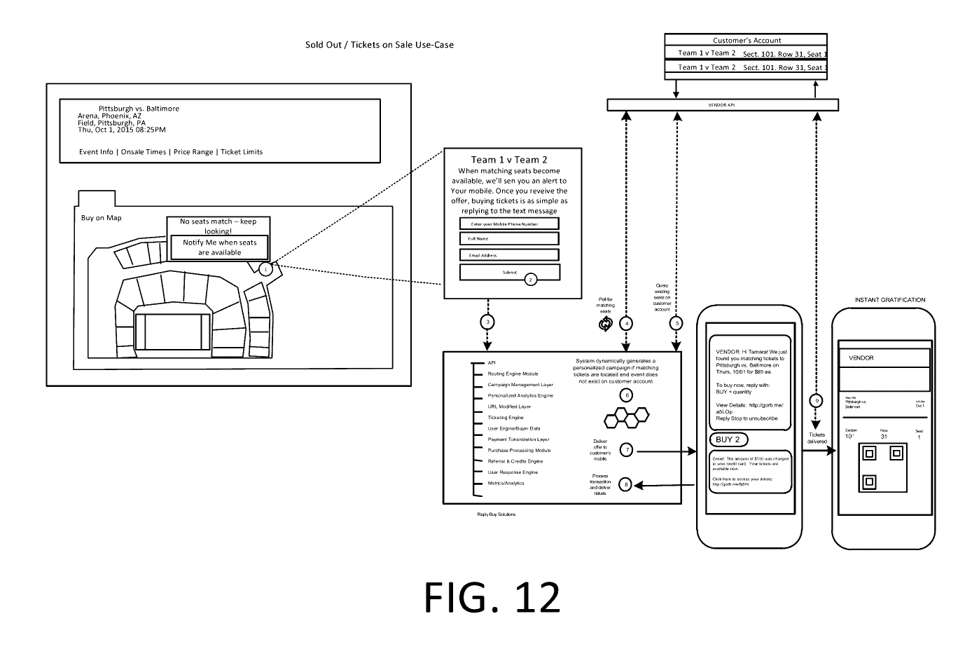

FIG. 12 is a flow chart showing steps to select a seat from a map. In step 1, the user is presented with a GUI which offers the ability to select a seat to an event. Such a selection may be preferred by a user because of its location. In the example, even though the user finds no seats currently available in the section of their choice, they may elect to “Notify Me When Seats are Available.” In such a way, the system knows this user's seat preference, and may be able to match in that section, or a similar section, that the user may still be interested in.

In step 2, the user is prompted to input more information about the request—price range, mobile phone number and/or other contact information, name, email, home address, etc.

Next, in step 3, the user submits the request to stay abreast of the concert information. In this step, the system is able to, through various back end systems including the API, routing engine module, campaign management layer, personalized analytics engine, URL modifier layer, Transfer Engine, User login/buyer data, payment transactions layer, purchase processing module, referral and credits engine, user response engine, and/or metrics/analytics conduct the matching, contact and fulfillment processes.

In step 4, the system communicates with the vendor and attempts to match the request with the available inventory. In step 5, the customer account information is also communicated from the vendor. In step 6, the customer account is updated. In step 7, the message is sent to the user's mobile phone, indicating that the request has been matched and that there is available inventory to be had. In step 8, the user sends a purchase acceptance with the mobile smartphone. After the back end system accepts the payment from the user, the bar code information is sent from the vendor to the user's mobile smartphone device. This is the information the user will utilize as the ticket, in this example.

Advertisement Examples

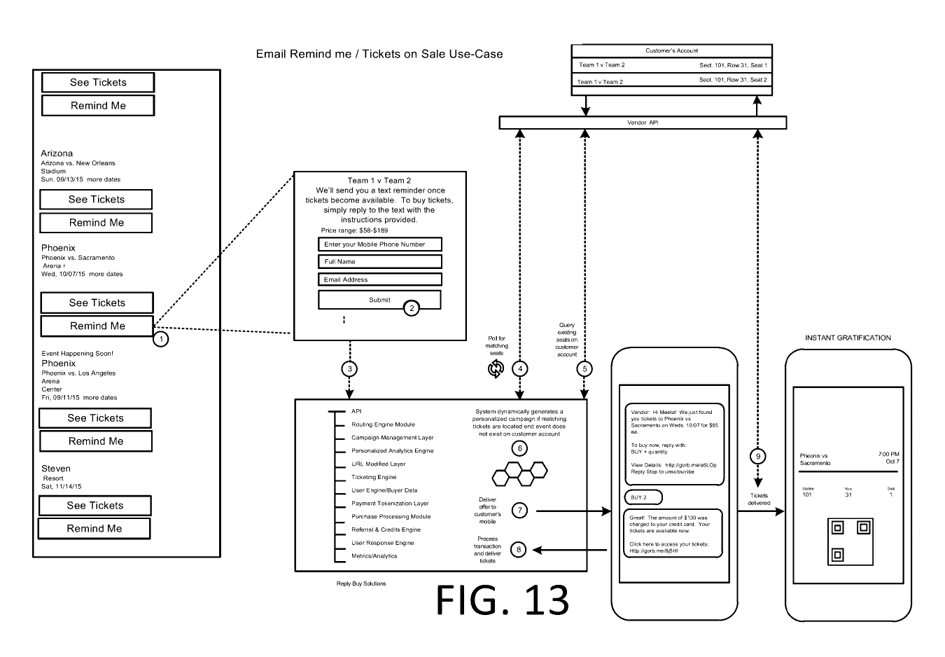

FIG. 13 is a flow chart showing steps of the system which in certain embodiments, are able to offer a ticket or a reminder in an advertisement. The example in FIG. 13 shows a GUI of an advertisement which the user can access through any of various ways such as through an email, website the user visits, or any of other various examples. The user in this example is seeing advertisements of various live concerts in the Phoenix, Arizona area. The specifics of the grouping by time, venue, location, etc. could include any of various groupings.

In step 2, the user is prompted to input more information about the request—price range, mobile phone number and/or other contact information, name, email, home address, etc.

Next, in step 3, the user submits the request to stay abreast of the concert information. In this step, the system is able to, through various back end systems including the API, routing engine module, campaign management layer, personalized analytics engine, URL modifier layer, Transfer Engine, User login/buyer data, payment transactions layer, purchase processing module, referral and credits engine, user response engine, and/or metrics/analytics conduct the matching, contact and fulfillment processes.

In step 4, the system communicates with the vendor and attempts to match the request with the available inventory. In step 5, the customer account information is also communicated from the vendor. In step 6, the customer account is updated. In step 7, the message is sent to the user's mobile phone, indicating that the request has been matched and that there is available inventory to be had. In step 8, the user sends a purchase acceptance with the mobile smartphone. After the back end system accepts the payment from the user, the bar code information is sent from the vendor to the user's mobile smartphone device. This is the information the user will utilize as the ticket, in this example.

More Network Examples

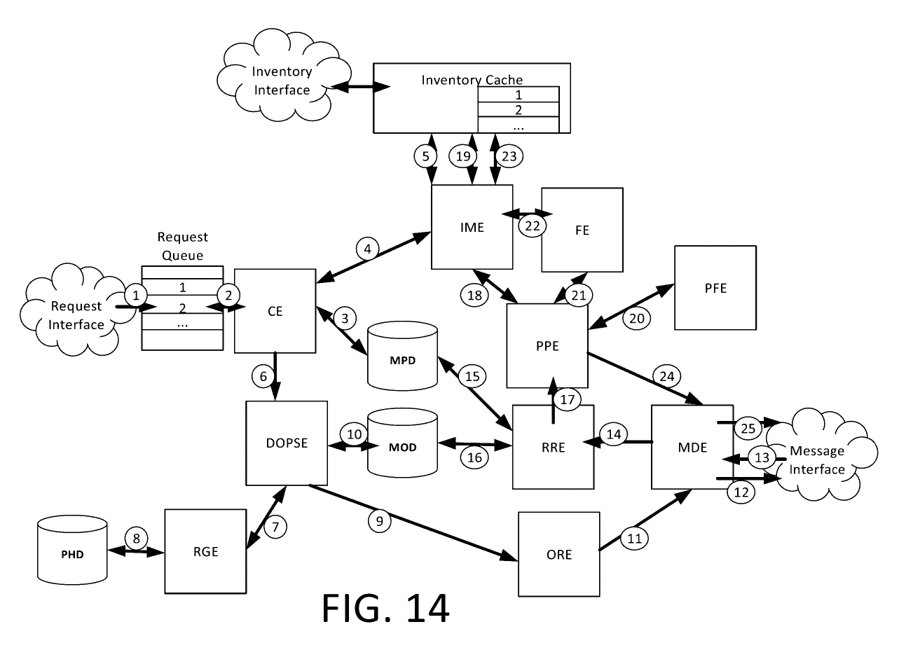

FIG. 14 shows an example Core network diagram of certain systems used in the embodiments described herein. In FIG. 14, steps are shown in sequence, with the acting back end systems are explained in more detail, in which a request is received, an inventory match is made, and an offer sent to the requesting user, according to certain example embodiments.

In this example, step 1 shows a request added to a Request Queue via a Request API. This is a request as described above, from a user, for a particular service or product. The Request Queue segments and prioritizes all requests according to date and time of request, vendor, request type, request parameters, and user details. Next, in step 2 the Comparator Engine CE fetches the request from the Request Queue and initiates processing of request. Next, in step 3, the CE fetches data of existing Mobile Profile from Mobile Profile Database MPD, if one exists. If one does not exist, one will be created. In step 4, the CE requests matching inventory from the inventory management engine IME and determines if there is a match, according to one or more of the following parameters: EventId, Performer Team, Event Date, Event Venue/Location, Section, Row, Seat(s), ProductId, Brand Name, EAN/UPC/ISBN, Quantity Available, Price/Price Range, Mobile Profile Location/Postal Code/Zip.

In step 5, the IME searches an Inventory Cache for matches across one or more parameters, requests refresh of Inventory Cache (via Inventory Interface) according to one or more of the parameters if no inventory found, and returns results to the CE. In step 6, if the CE determines there is a match, the CE provides the Request, matching Inventory and Mobile Profile data to the dynamic personalization and segmentation engine DOPSE. In step 7, the DOPSE provides Mobile Profile data to the reward and gamification engine RGE. In step 8, RGE fetches purchase history from the purchase history database PHD, determines if Mobile Profile qualifies for Reward or Gamification benefits, and returns results to DOPSE.

In step 9, using various artificial intelligence techniques, and leveraging specific vendor and user data including but not limited to event venue, performer(s) or team/opponent, user purchase history, user preferences, user interests, user spending habits, geo-fence and user location, DOPSE generates a tailored, custom offer and delivers to the offer routing engine ORE. In step 10, the DOPSE may also save the Mobile Offer record to the mobile offer database MOD to register that an offer has been generated per the request, according to the Mobile Profile. In step 11, the ORE prioritizes an offer message, appends recipient information according to the Mobile Profile, and provides prepared message data to the message delivery engine MDE. In step 12, the MDE delivers the message to a requesting user via a Message Interface. Step 13 is when the MDE receives reply message from recipient. In step 14, the MDE provides reply message data to the response routing engine RRE.

In step 15, the RRE fetches corresponding Mobile Profile from the mobile profile database MPD according to reply message sender/origin. In step 16, the RRE fetches pending Mobile Offer from MPD according to the Mobile Profile. In step 17, if the RRE determines the reply to be a valid purchase request, the Mobile Profile exists, and Mobile Offer is actually pending, the RRE provides Mobile Profile data and request details to the purchase processing engine PPE. In step 18, the PPE queries the IME for remaining inventory, corresponding to Mobile Offer. Next, in step 19, the IME locates corresponding inventory and reserves inventory, if a reservation of inventory is possible. Next, in step 20, if remaining inventory exists, PPE provides the Mobile Profile data and engages the payment facilitator engine PFE for payment processing. In step 21, once the PFE processes payment successfully, the PPE engages the fulfillment engine FE to mark corresponding inventory as SOLD and in certain embodiments, requests Updated Inventory Details, for example, in the form of a Dynamic Inventory Barcode. In step 22, the FE notifies the IME to mark inventory as SOLD and requests Updated Inventory Details. In step 23, the IME marks inventory as SOLD and returns Updated Inventory Details to the FE. The FE in turn, returns Updated Inventory Details to the PPE. The IME may then immediately notify the external Inventory owner to mark the service or product as sold along with marking it in the internal system. Next, in step 24, the purchase processing engine PPE generates purchase confirmation message and routes to the message delivery engine MDE. Finally, in step 25, the MDE delivers the purchase confirmation message to the user requesting the services or items via the Message Interface.

In such a way, the system is able to receive a request, fulfill the request and send out an offer to the requesting user. The acceptance of the offer may then be coordinated with the vendor in order to ensure the service or product is reserved by the purchasing user.

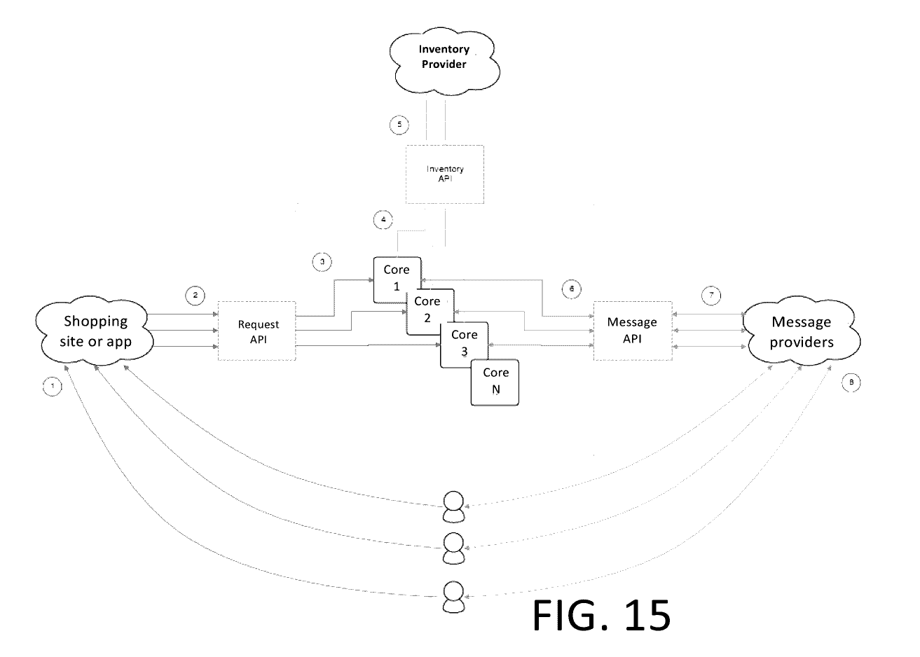

In yet another example, FIG. 15 shows an example diagram of a Solution utilizing networks and back end systems to practice the embodiments described herein. This example includes ticket purchases by wireless users.

In this example, step 1 includes a request made by end users at a Ticketing Shopping Portal. Such a portal may be a third party vending website, whereas in other example embodiments, a proprietary system integrated with the other aspects of the back end systems here may be used. In step 2, the requests are routed by the Ticketing Shopping Portal to the ReplyBuy Request API. In step 3, the requests are routed by the ReplyBuy Request API to one of N ReplyBuy Cores. In step 4, the ReplyBuy Cores request and synchronize Inventory Caches via the Inventory API. In step 5, the Inventory Update Requests are routed to and from the Ticketing Inventory Provider via the Inventory API. In step 6, the messages intended to be delivered to and from end users are routed via the Messaging API. In step 7, the messaging API routes messages to and from Message Providers. And finally in step 8, the messages are delivered to and received from end users by the Messaging Providers.

Such messages could be any kind of message as described herein, such as an SMS text message, MMS message, etc. to a smartphone used by the requesting user.

Example Gamification Examples

Certain example embodiments may include gamification and/or incentivized offers depending on users' purchase history. Thus, the gamification engine from FIG. 14 may be able to keep track of users' previous purchases and help create campaigns or offers which incentivize later purchases, based on previous purchase history and utilize any kind of reward, giveaway, discount, point, icon collection or other incentive in subsequent offers.

In an example of rewards/gamification, a user who has previously purchased an item may be presented with an offer for a subsequent item that has an incentive based on that specific user's previous purchase or purchasing history. This new offer may reference the previous purchase, reference various incentives, and/or inform the user that more purchases will result in better discounts and/or other incentives.

In certain embodiments the vendor may present the user with incentivized material based on their purchase history. Such incentivized material may be generated by the vendor with information provided by the systems here. In certain embodiments, the vendor could set parameters of what the system may allow for. A vendor could then set the incentive increments, and the system would allow the vendor or system to present the incentives to the user.

Example Communications

In certain example embodiments, the communication that is sent by the systems to a user smartphone may include any different kind of information. The communication could be in the form of a text SMS message. For example, the text message may be personalized and segmented according to data provided by an end user customer.

In one example of the text message offer sent to the buyer's phone may be “Hi [First Name]. We found you tickets for the [Event Name] event, which you previously requested. Seats located in Section [Section], Row [Row] for price [Price]. To buy now, reply with: BUY+quantity”

In another example, the message is, “Hi [First Name]. We found you tickets for the [Event Name] event, which you previously requested. Seats located in Section [Section], Row [Row] for price [Price]. To buy now, visit [URL]”

Where [First Name] is the buyer's First Name, [Event Name] is the name of the Preferred Event, [Section] and [Row] are the ticket location Section and Row of the matching ticket(s) (may or may not correspond to Preferred Ticket Seat Location), [Price] is the per-ticket Price of the matching ticket(s), and [URL] is an internet website URL.

Example Personalized Information Data

In certain examples the system may be able to utilize the identifiers for a particular user, access third party or other gathered information about that user, and utilize that information in the incentive system as described herein.

For example, a user may provide identifying details to the system. The system may then research more about that user, and based on what research returns, ingest data about that user to customize offers, incentives or campaigns.

Example Computing Device

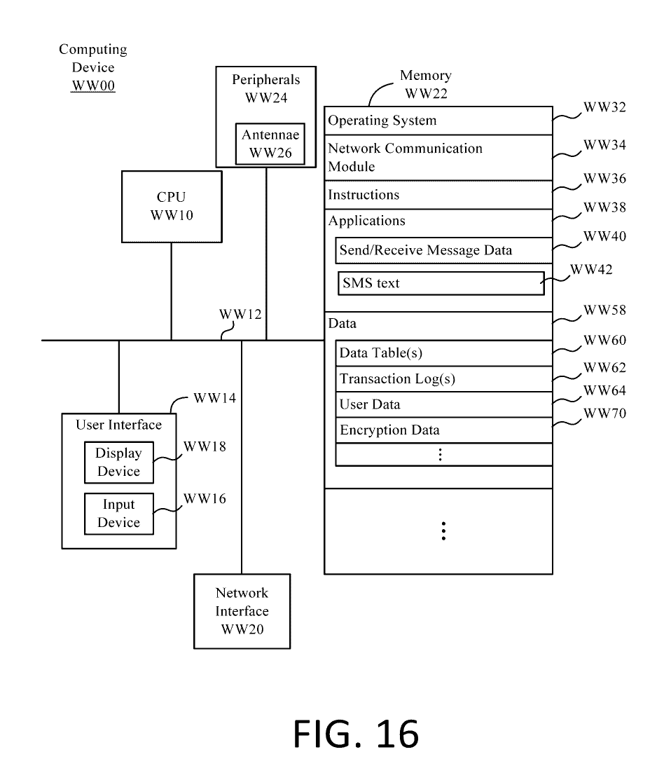

FIG. 16 shows an example computing device WW00 that may be used in practicing certain example embodiments described herein. In FIG. 16, the computing device could be a smartphone, a laptop, tablet computer, or any other kind of computing device. The example shows a processor CPU WW10 which could be any number of processors in communication via a bus WW12 or other communication with a user interface WW14. The user interface WW14 could include any number of display devices WW18 such as a screen. The user interface also includes an input such as a touchscreen, keyboard, mouse, pointer, buttons or other input devices. Also included is a network interface WW20 which may be used to interface with any wireless or wired network in order to transmit and receive data. Such an interface may allow for a smartphone, for example, to interface a cellular network and/or WiFi network and thereby the Internet. The example computing device WW00 also shows peripherals WW24 which could include any number of other additional features such as but not limited to an antennae WW26 for communicating wirelessly such as over cellular, WiFi, NFC, Bluetooth, infrared, or any combination of these or other wireless communications. The computing device WW00 also includes a memory WW22 which includes any number of operations executable by the processor WW10. The memory in FIG. 16 shows an operating system WW32, network communication module WW34, instructions for other tasks WW38 and applications WW38 such as send/receive message data WW40 and/or SMS text message applications WW42. Also included in the example is for data storage WW58. Such data storage may include data tables WW60, transaction logs WW62, user data WW64 and/or encryption data WW70.

The system and method for request fulfillment and offer/acceptance communication as described above uses known computing elements and software that executes on the computing elements to achieve the benefits of the system and method. The software has various instructions that perform the process described above that are like rules and are an inventive concept that is distinguishable over conventional system and methods for request fulfillment. Furthermore, the system and method provide an improved technical result for request fulfillment using the processes described above which are an advance and are an inventive concept over the conventional system as described above.

1. An apparatus, comprising:
an order fulfillment system that has an interface that is configured to receive a request for an item from a consumer using a computing device, the item being unavailable for purchase at a time of the request for the item, the request for the item including contact details for the consumer and an interface that is configured to receive information about an availability of the requested item from a vendor system at a time later than the time of the request;
the order fulfillment system having a matching system that matches the received request for the item from the consumer with the availability information for the requested item from the vendor system to identify that the requested item is available for purchase by the consumer; and
the order fulfillment system having an alerting system that electronically alerts the consumer, using the contact details of the received request from the consumer, that the requested item is available for purchase.

2. The apparatus of claim 1, wherein the order fulfillment system further comprises a payment system that receives an acknowledgement of purchase of the requested item by the consumer.

3. The apparatus of claim 2, wherein the request for the item further comprises payment information for the consumer and the payment information is used to purchase the requested item when the acknowledgment of the purchase of the requested item is received.

4. The apparatus of claim 1, wherein the alerting system communicates an offer for a purchase of the requested item, an explanation of the offer for the purchase of the requested item and a way for the consumer to purchase the requested item.

5. The apparatus of claim 1, wherein the alerting system generates one of a smartphone message to electronically alert the consumer, an SMS message to electronically alert the consumer, an MMS message to electronically alert the consumer and a cellular network message to electronically alert the consumer.

6. The apparatus of claim 1, wherein the item is one of a product and a service.

7. The apparatus of claim 1, wherein the item is a ticket to a sporting event.

8. The apparatus of claim 1, wherein the item is a ticket for an event wherein the event is one of a sports game, a movie, a transportation event and a live event.

9. The apparatus of claim 1 further comprising a vendor system that communicates with the order fulfillment system.

10. The apparatus of claim 1 further comprising a vendor system into which the order fulfillment system is integrated.

11. The apparatus of claim 2, wherein the payment system is PCI compliant.

12. A method for request fulfillment, comprising:
receiving a request for an item from a consumer, the item being unavailable for purchase at a time of the request for the item, the request for the item including contact details for the consumer;
receiving information about an availability of the requested item from a vendor system at a time later than the time of the request;
matching the received request for the item from the consumer with the availability information for the requested item to identify that the requested item is available for purchase by the consumer; and
electronically alerting the consumer, using the contact details of the received request from the consumer, that the requested item is available for purchase.

13. The method of claim 12 further comprising receiving an acknowledgement of purchase of the requested item.

14. The method of claim 13, wherein the request for the item further comprises payment information for the consumer and further comprising purchasing the requested item using the payment information when the acknowledgment of the purchase of the requested item is received.

15. The method of claim 12, wherein electronically alerting the consumer further comprises communicating an offer for a purchase of the requested item, an explanation of the offer for the purchase of the requested item and a way for the consumer to purchase the requested item.

16. The method of claim 12 further comprising browsing, by the consumer, a vendor site for the requested item and determining, by the consumer that the requested item is unavailable before sending the request for the item.

17. The method of claim 12, wherein electronically alerting the consumer further comprising one of using a smartphone to electronically alert the consumer, using an SMS message to electronically alert the consumer, using an MMS message to electronically alert the consumer and using a cellular network message to electronically alert the consumer.

18. The method of claim 12, wherein the item is one of a product and a service.

19. The method of claim 12, wherein the item is a ticket to a sporting event.

20. The method of claim 12, wherein the item is a ticket for an event wherein the event is one of a sports game, a movie, a transportation event and a live event.
